(19) United States
(12) Patent Application Publication
(10) Pub. No.: US 2007/0240128 A1
(43) Pub. Date: Oct. 11, 2007

(54) Systems and methods for generating a user interface using a domain specific language

(76) Inventors: Richard D. Patton, Hastings, MN (US); Phillip Wayne Patton, Hastings, MN (US); Thomas Tung Nguyen, Brooklyn Park, MN (US); Leon Curtis Johnson, Inver Grove Heights, MN (US)

Correspondence Address: SCHWEGMAN, LUNDBERG & WOESSNER, P.A., P.O. BOX 2938, MINNEAPOLIS, MN, 55402, US

(21) Appl. No.: 11/400,047

(22) Filed: Apr. 7, 2006

(51) Int. Cl. G06F 9/45; G06F 9/44

(52) U.S. Cl. 717/136; 717/106

(57) ABSTRACT

Systems and methods generate user interfaces using a description of a business ontology and a pattern language describing a layout for business objects in the business ontology. The layout description is analyzed and code may be generated to produce the output layout according to the layout description. One aspect of the system and methods includes generating HTML code. A further aspect of the system and methods includes generating Java Swing code. A still further aspect of the systems and methods includes generating user interface code for a desktop application. The layout description may describe a layout in a manner that is display device independent, and that does not rely on absolute positioning of elements. Business object data and fields within a business object may be positioned relative to one another and may further be positioned based on the order in the layout description.

### FIELD

The embodiments of the present invention relate to generating user interfaces. More specifically, the embodiments relate to a domain specific language for generating a user interface.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright © 2006 Lawson Software, Inc.

### BACKGROUND

Business software applications play an important role in running almost every business in operation today. Applications such as general ledger, time and accounting, human resources and other applications enable business to run efficiently and comply with regulatory requirements.

Developing and modifying business software applications typically requires the involvement of many people. For example, business analysts may be required in order to specify the functionality required by the application. Once the functionality has been identified, teams of software developers may then be needed to create the software making up the application. As a result, creating and modifying business software applications, including the user interfaces for such applications, can be a labor intensive and expensive process.

### SUMMARY

Systems and methods generate user interfaces using a description of a business ontology and a pattern language describing a layout for business objects in the business ontology. The layout description is analyzed and code may be generated to produce the output layout according to the layout description. One aspect of the system and methods includes generating HTML code. A further aspect of the system and methods includes generating Java Swing code. A still further aspect of the systems and methods includes generating user interface code for a desktop application.

The layout description may describe a layout in a manner that is display device independent, and that does not rely on absolute positioning of elements. Business object data and fields within a business object may be positioned relative to one another and may further be positioned based on the order in the layout description.

### BRIEF DESCRIPTION OF THE DRAWINGS

FIG. 1 is a diagram illustrating user interface components used in some embodiments.

FIG. 2 is a diagram illustrating the major components of a system according to embodiments of the invention.

FIG. 3 is a flowchart illustrating an exemplary method for generating a user interface according to embodiments of the invention.

FIG. 4A is a flowchart illustrating a method for processing panels of a layout according to embodiments of the invention.

FIG. 4B is an example pattern language segment illustrating a definition of a panel.

FIG. 4C is an example screen output displayed according to the example pattern language segment of FIG. 4B.

FIG. 4D is a further example pattern language segment illustrating a definition of a panel.

FIG. 4E is an example screen output displayed according to the example pattern language segment of FIG. 4D.

FIG. 5A is a flowchart illustrating a method for processing a list of display fields according to embodiments of the invention.

FIG. 5B is an example pattern language segment illustrating a definition of a list of display fields.

FIG. 5C is an example screen output displayed according to the example pattern language segment of FIG. 5B.

FIG. 6A is a flowchart illustrating a method for processing a form according to embodiments of the invention.

FIG. 6B is an example pattern language segment illustrating a definition of a form.

FIG. 6C is an example screen output displayed according to the example pattern language segment of FIG. 6B.

FIG. 7A is a flowchart illustrating a method for processing a composite form according to embodiments of the invention.

FIG. 7B is an example pattern language segment illustrating a definition of a composite form.

FIG. 7C is an example screen output of a first page of a composite form displayed according to the example pattern language segment of FIG. 7B.

FIG. 7D is an example screen output of a second page of a composite form displayed according to the example pattern language segment of FIG. 7B

FIG. 8A is a flowchart illustrating a method for processing a paragraph section according to embodiments of the invention.

FIG. 8B is a flowchart illustrating a method for processing a column section according to embodiments of the invention.

FIG. 8C is an example pattern language segment illustrating a definition of a paragraph section and a column section.

FIG. 8D is an example screen output displayed according to the example pattern language segment of FIG. 8C.

### DETAILED DESCRIPTION

In the following detailed description, reference is made to the accompanying drawings that form a part hereof, and in which is shown by way of illustration, specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the Figures, the same reference number is used throughout to refer to an identical component which appears in multiple Figures. Signals and connections may be referred to by the same reference number or label, and the actual meaning will be clear from its use in the context of the description.

The functions or algorithms described herein are implemented in hardware, and/or software in embodiments. The software comprises computer executable instructions stored on computer readable media such as memory or other types of storage devices. The term “computer readable media” is also used to represent software-transmitted carrier waves. Further, such functions correspond to modules, which are software, hardware, firmware, or any combination thereof. Multiple functions are performed in one or more modules as desired, and the embodiments described are merely examples. A digital signal processor, ASIC, microprocessor, or any other type of processor operating on a system, such as a personal computer, server, a router, or any other device capable of processing data including network interconnection devices executes the software.

Some embodiments implement the functions in two or more specific interconnected hardware modules or devices with related control and data signals communicated between and through the modules, or as portions of an application-specific integrated circuit. Thus, the example process flow is applicable to software, firmware, and hardware implementations.

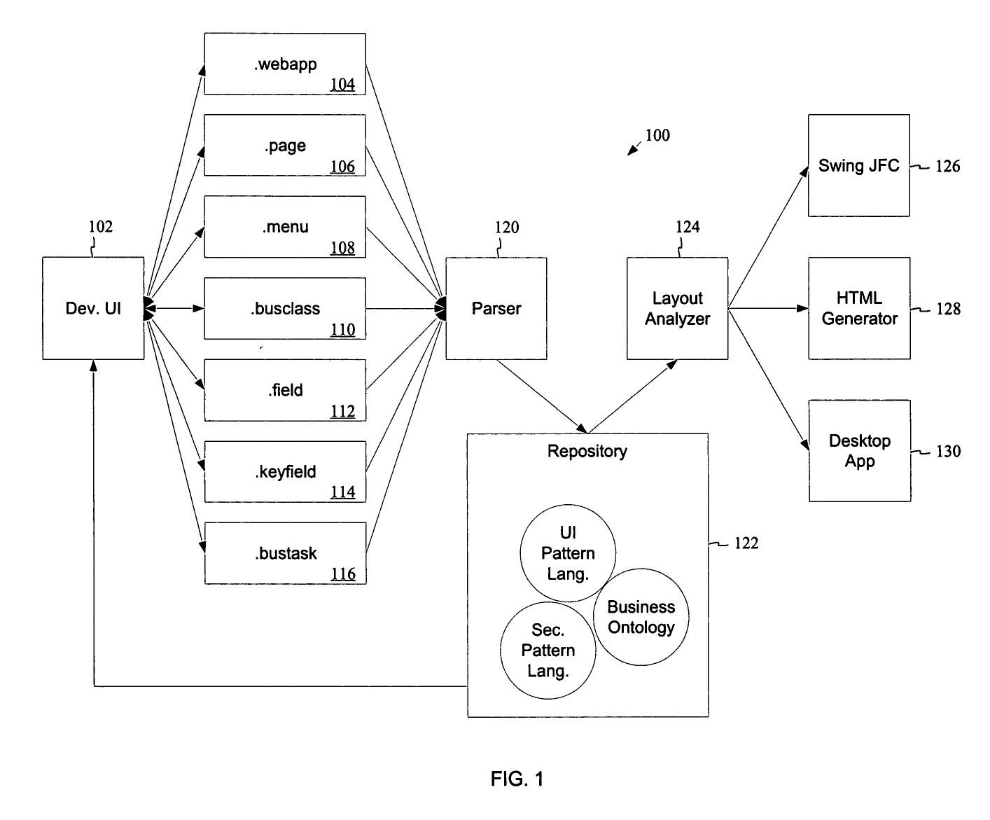

FIG. 1 is a diagram illustrating the major components of a system 100 according to embodiments of the invention. In some embodiments, system 100 includes development environment 102, parser 120, repository 122, layout analyzer 124, and code generators 126, 128 and 130. Development environment 102 may provide a graphical user interface useful in specifying a business ontology defining data and business rules to be applied to the data for a to a business application under development. In some embodiments, development environment provides an interface for specifying a business ontology using a pattern language. In particular embodiments, the pattern language is the Lawson Pattern Language (LPL) developed by Lawson Software of St. Paul, Minn. In some embodiments, development environment 102 may place pattern language elements into several different files depending on the functionality or data provided by the pattern language elements. In some embodiments, these files include a .webapp file 104, a .page file 106, a .menu file 108, a .busclass file 110, a .field file 112, a .keyfield file 114, and a .bustask file 116. .Webapp file 104 may contain pattern language elements that may be used to define aspects of a business application. .Page file 106 may contain pattern language elements used to define one or more pages of an application. .Menu file 108 may contain pattern language elements used to define menus used by a business application. .Busclass file 110 may be used to contain pattern language elements defining various business classes for a software application. .Field file 112 may be used to contain pattern language elements defining data fields used by business classes. .Keyfield file 114 may contain pattern language elements identifying key fields for one or more business classes. .Bustask file 116 may contain pattern language elements defining business tasks to be executed by a business application. Further details on the pattern language elements contained in the above-described files will be described below.

Parser 120 parses the pattern language defining the data and business rules into business objects for storage in repository 122. In some embodiments, parser 120 reads the files described above and parses pattern language elements found in the files. In addition, parser 120 may parse pattern language elements defined within the development environment 102 prior to the pattern language element being placed in a file. The business objects produced by parser 120 comprise a translation of the business rules and data into an object for that is more easily processed by a computer system. A BNF (Bachus Naur Form) specification for LPL used in some embodiments is provided in Appendix A of this specification. The parser 120 may follow the syntax rules defined within the BNF in order to parse pattern language elements. In some embodiments, the business objects may be parsed into Java language objects.

Repository 122 is a database designed to store the business objects produced by parser 120. Repository 122 may be any type of database. In some embodiments, repository 122 may be a relational database. However, repository 122 may be a hierarchical database, an object-oriented database, or a database comprising one or more files in a file system. In some embodiments, the repository includes a business ontology specifying the attributes and business rules for various business classes. A business class is typically a user defined set of attributes and rules that are related in some way. For example, a business class describing an employee may include attributes that specify the employees name, title, tax identification number, address, salary etc. Repository 122 may also include user interface pattern language elements and security pattern language elements associated with the business class. User interface pattern language elements may be used to define how objects in the business ontology are presented to the user. For example, the user interface pattern language elements may define pages, menus, panes, and columns for displaying data related to business objects. Further details on these pattern language elements will be provided below.

Layout analyzer 124 reads repository 122 to obtain the business objects, and the user interface pattern language elements used to define the layout for the business object data, and in conjunction with the current display properties (e.g. display height, width and resolution) determines how the business object data defined using the business ontology are to appear to a user. It should be noted that the layout defined by the user interface pattern language is independent of the screen size and resolution. Additionally, the user does not need to provide positions for the user interface elements, rather the user specifies the elements to appear on the screen and the layout analyzer determines the positioning of the user interface elements. For example, if an application designer specifies using the UI pattern language that the output is to appear in two columns, the layout analyzer will fit the data into two columns according to the current screen height, width and resolution. A Layout analyzer then uses code generators 126-130 to generate code to display the data in the objects defined using the business ontology.

In some embodiments, layout analyzer 124 invokes a Swing JFC (Java Foundation Class) to generate code to display business object data. The Swing JFC is a toolkit providing a UI component library implemented in the Java programming language. The Swing package uses the windowing functionality of AWT and the rendering capabilities of the Java 2D API to provide UI components that comply with the JavaBeans specification. Further details on Swing may be found in the Java™ 2 Platform, Standard Edition, v 1.4.2 API Specification.

In some embodiments, the layout analyzer invokes HTML generator 128 to generate HTML (Hyper Text Markup Language) code that displays the objects defined by the business ontology as a web page.

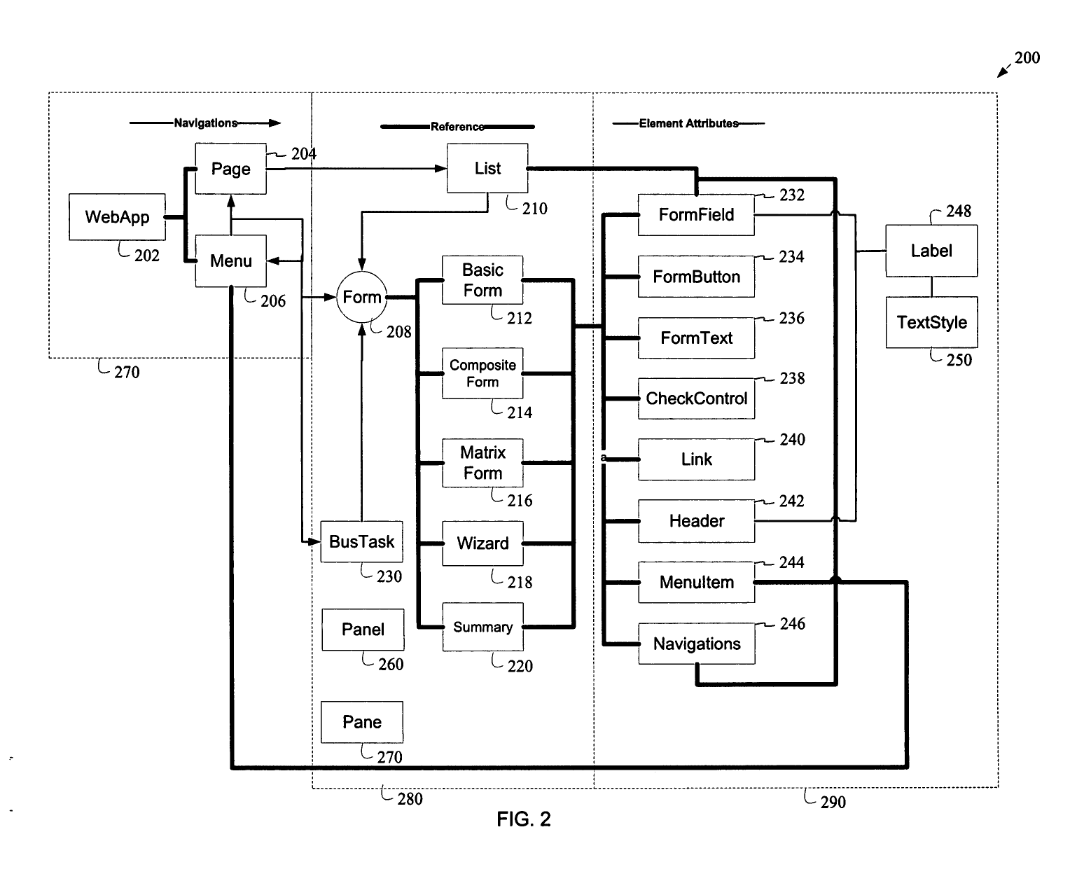

FIG. 2 is a diagram illustrating user interface pattern language elements 200 used in some embodiments. The user interface pattern language elements may include application elements 270, component (also referred to as container) elements 280, and core elements 290. In general, application elements 270 may contain component elements 280, which in turn may contain core elements 290.

Application elements 270 may include webapp 202 elements, page elements 204, and/or menu elements 206. WebApp 202 defines elements for an application within a product line. The elements may include a home page, a navigation bar, a registration key and may determine whether anonymous access (e.g. access without specifying a user name/password combination) is allowed to the application.

Page elements 204 define one or more pages of an application. In some embodiments, a page may be composed of panels, and has a scoping level that is the same as a business class. As a result, a page may include data from multiple business objects in different business classes by defining one panel to have data for objects in a first business class an another panel having data for objects in a second business class.

Menu elements 206 define menus for a user interface. In some embodiments, a menu element 206 specifies a list of one or more menu items 244 for the menu. Each of the individual menu items 244 may refer to other menu elements 206, page elements 204 or one of the component elements 280 described below. Further, in some embodiments, menu elements 206 may be nested within other menu elements 206 to create sub menus that are in-lined with the current menu definition.

In some embodiments, component elements 280 may include form elements 208, list elements 210, business task elements 230, panel elements 260 and pane elements 270. A form element 208 may be a basic form element 212, a composite form element 214, a matrix form element 216, a wizard form element 218 or a summary form element 220.

A basic form element 212 comprises a default style form. The basic form element includes fields that designate a title for the form, indicate whether the form is a primary form, indicate an action (e.g. “create”, “read”, “update”, or “delete” or derivations thereof) associated with the form, and a layout for the form. The layout may include core elements 290 that are to be displayed within the form.

A composite form element 214 is a specialized type of form that may include one or more panel elements, where each of the panel elements is either a type of form element 212-220 or a list element 210.

A matrix form element 216 is a specialized type of form in which the a matrix of cells is displayed. The columns and cells may be defined as business object data. In addition, rows and columns of the matrix may be specified using links to related object (e.g. through key fields or other link mechanisms) so that related data may be displayed in the matrix.

A wizard form element 218 is a specialized type of form in which a first form may be displayed. A “next” action is defined, which may be used to lead a user to a next form, list or page. In addition, actions may be defined to validate the form before the “next” step of the wizard form may be executed.

A summary form element 220 is a specialized type of form that provides for the display of business object data in a form, but typically does not provide any actions that may be taken with respect to the form. For example, a summary form element may be displayed after a series of wizard form elements have lead a user through the steps in providing or updating business object data to show the end results of the wizard forms.

List elements 210 defines how a list of business objects in a particular business class may be displayed in a page, pane or panel. Conditions may be specified to select which business objects are displayed. Further, criteria may be specified to sort the list. In addition, actions such as create, read, update or delete a business object in a list may be specified within a list element. The data for the business objects may be scrolled if more data is displayed than fits on a page, pane or panel.

A business task element 230 specifies a business action, process or transaction and any associated parameters and other attributes of a business related action, process or transaction that may be executed as a result of a menu selection.

A panel element 260 defines a portion of a page. For example, if business objects for multiple different business classes are to be displayed on a page, multiple panels, one for each business class, may be defined for the page. Each panel may be defined to display business object data in a desired format (e.g. list or form).

Pane elements 270 define panes for a panel element 260. In some embodiments, a panel may be displayed as one, two, three or four panes corresponding to upper, lower, left and right portions of a panel. However, the embodiments are not limited to any particular number of pane elements for a panel.

As noted above, lists and forms may be formed from core elements 290. In some embodiments, these core elements include one or more of form field 232, form button 234, form text 236, check control 238, link 240, header 242, menu item 244, and navigations 246. A form field 232 or a header 242 may additionally specify a label 248 and/or a text style 250.

Form field 232 defines how a field is to be displayed for a form or list. Various parameters may be used to define how a field is to be displayed. For example, a field label may be defined for the field. Additionally, indentation and alignment (left, center, right), and a line size for the field may be defined.

Form button 234 is a user interface element that provides a specification of a button to be placed on the user interface. Form button 234 in some embodiments includes grammar elements that allow a user to specify label text to appear on the button, a condition specifying when the button is valid (i.e. when the button may be enabled), a form to invoke upon activating the button or an action to perform upon activating the button.

Form text 236 provides a user interface element that allows a user to specify text to appear on a form.

Check control 238 includes grammar elements that allow a user to specify a check box that appears on a form or list. In some embodiments, the user may specify a label for the check box, a condition indicating when the check box is valid, a field in a business object that contains the current state (checked vs. unchecked) of the check box, an action to perform when the check box is checked by a application user, and an action to perform when the check box is unchecked.

Link 240 is an element that provides a link to another form, list, or external user interface (for example, a web page).

Header 242 includes grammar elements allowing a user to define a header for a list or form. In some embodiments, the user may specify a header message and a header style to control how the header is presented.

Menu item 244 provides grammar elements for defining an individual menu item within a menu 206. The grammar elements define what happens when the menu item is selected by an application user. In some embodiments, the grammar elements allow an application designer to specify a page, list or form to be displayed upon selection of the menu item. Further, the menu item may define an action (e.g. a business task) to be performed if the menu is selected. Also, the menu item may specify an HTML link to be invoked upon menu item selection. Additionally, the menu item may cause another menu to be displayed upon selection.

Navigation 246 allows an application designer to specify a link to a URL, page, form or list that is displayed upon selection of the navigation element.

Label 248 is a grammar element that provides a mechanism for an application designer to associate a label with a field 232 or header 242. The label may provide text for a description or indicator of what the field or header is used for.

Text style 250 is a grammar element that provides a mechanism for an application designer to have different text styles applied to display elements such as form fields 232 or header 242. The text style may specify that the text for a field or header is to be left, right, or center justified. In addition, the text style may specify that the text is to be displayed in a bold or italic style.

Further details on the elements described above are provided in Appendix A, which is a BNF (Backus Naur Form) definition file providing a syntax and grammar definition for a pattern language used in some embodiments of the invention.

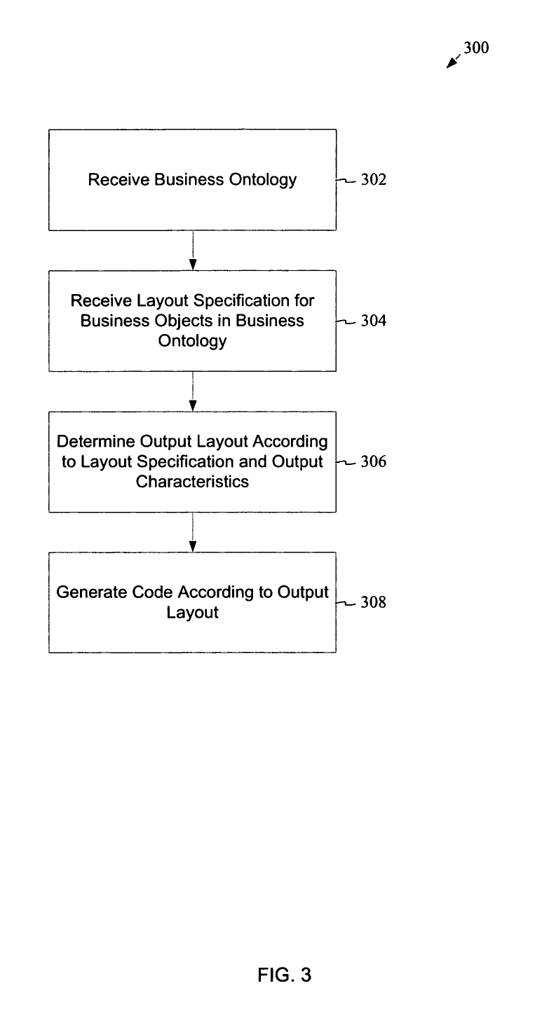

FIGS. 3, 4A, 5A, 6A, 7A and 8A illustrate flow diagrams of methods generating a user interface from grammar elements in a pattern language. The methods to be performed by the operating environment constitute computer programs made up of computer-executable instructions. Describing the methods by reference to a flowchart enables one skilled in the art to develop such programs including such instructions to carry out the methods on suitable computers (the processor or processors of the computer executing the instructions from computer-readable media such as ROMs, RAMs, hard drives, CD-ROM, DVD-ROM, flash memory etc. The methods illustrated in FIG. 3, 4A, 5A, 6A, 7A and 8A are inclusive of acts that may be taken by an operating environment executing an example embodiment of the invention.

FIG. 3 is a flowchart illustrating an exemplary method for generating a user interface according to embodiments of the invention. The method begins by receiving a business ontology (block 302). The business ontology may include business objected defined based on business classes specified using a pattern language. In some embodiments, the business objects definitions are parsed and stored in a repository.

Next, the system receives a layout specification for the business objects in the business ontology (block 304). In some embodiments, the layout specification is provided using grammar elements defined in the pattern language used to define the business objects. As discussed above, the layout specification may include definitions for pages, menus, panels, forms, lists and menus. In addition, the layout specification may specify how fields are to appear on forms and lists. In some embodiments, the layout specification is defined without reference to absolute positioning of the various elements. Rather, the layout specification identifies the display elements that are to appear on the screen, and in some cases a relative positioning or order. For example, panes may be specified as appearing in an upper or lower position, or in an upper left, upper right, lower left, or lower right position. Further, some display elements may be specified to occupy a particular percentage of the available page, panel, or pane size. Additionally, some display elements may be specified as occupying a particular number of lines on a display.

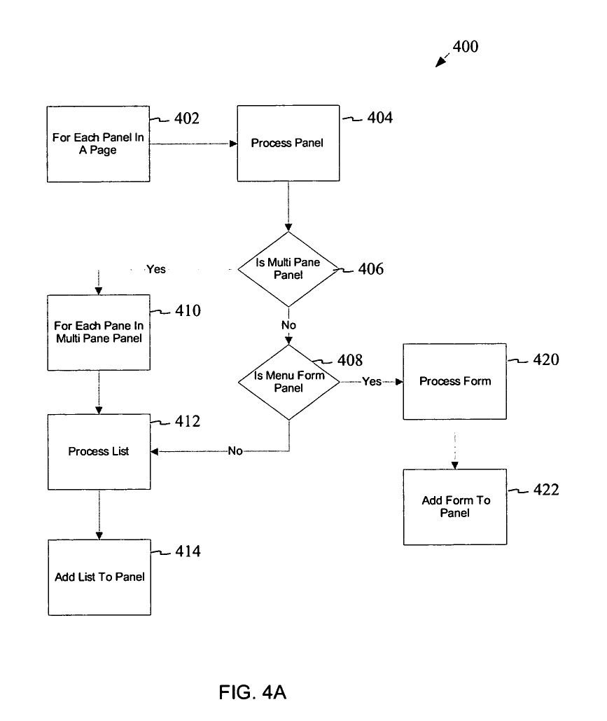

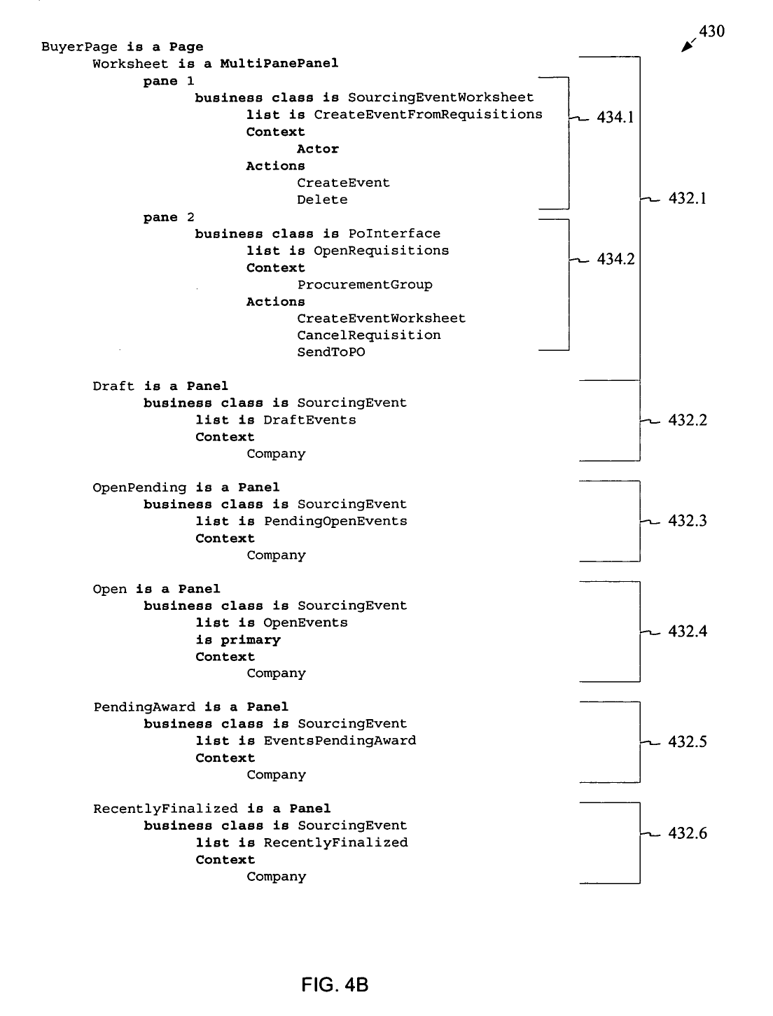

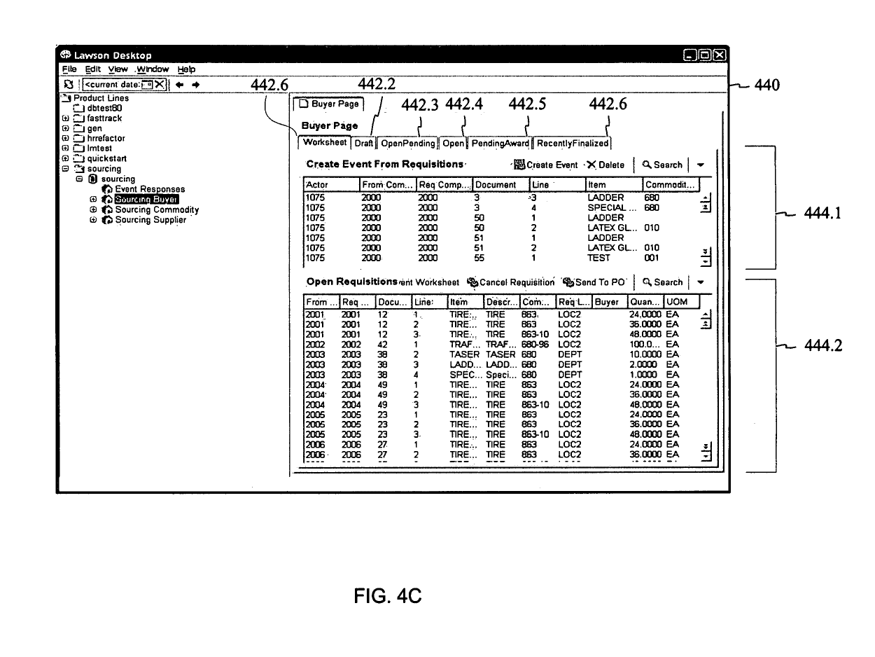

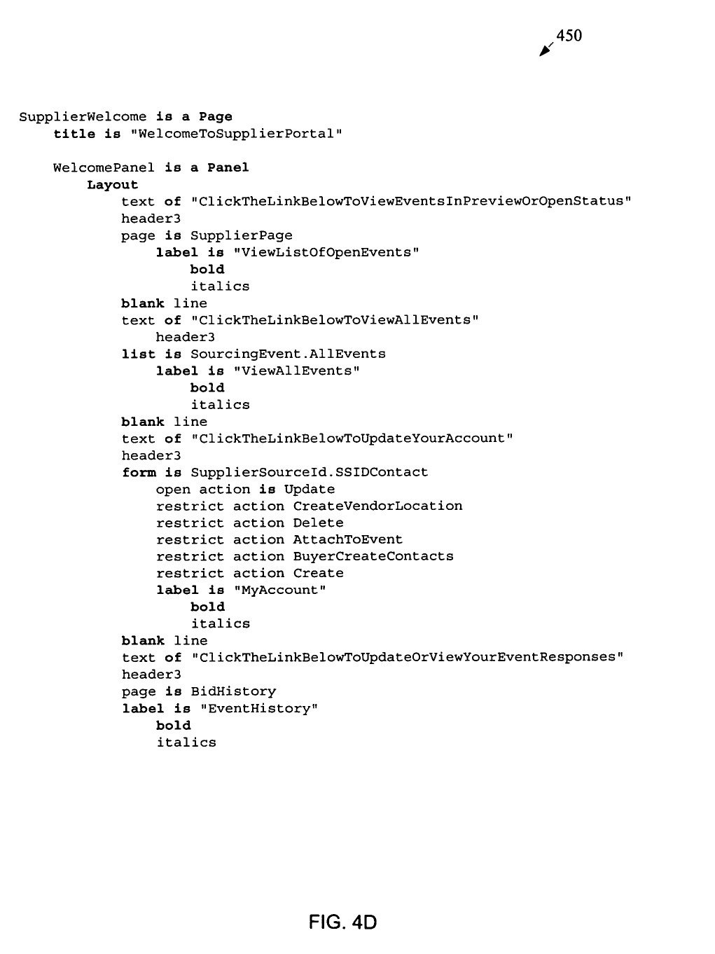

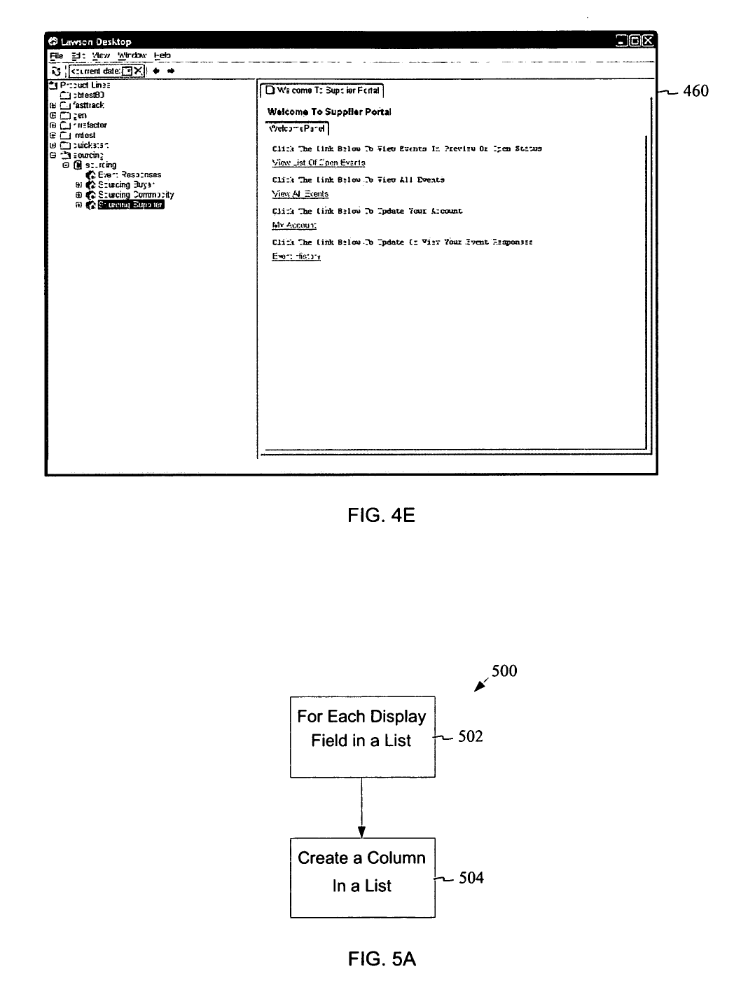

The system then determines the output layout according to the layout specification and the output characteristics (block 306). In some embodiments, the system determines the positioning of the various user interface elements defined in the layout specification based on the available screen output characteristics (e.g. screen height, width and resolution). Further details on various layout processing are provided below with reference to FIGS. 4A-8D.

The system then generates code to display the user interface elements specified by the layout description and as determined by the output layout (block 308). In some embodiments, HTML code may be generated. In alternative embodiments, Java code conforming to the Java Swing API may be generated. In further alternative embodiments, code conforming to a Microsoft Windows desktop API may be generated.

FIG. 4A is a flowchart illustrating a method for processing a page of a layout according to embodiments of the invention. The method begins by determining one or more panels defined for a page (block 402). For a panel on a page, the system begins initial processing of the panel (block 404).

The system determines if the panel is a multi-pane panel (block 406). If the panel has multiple panes, the system performs steps 412 and 414 for each pane (block 410). The system processes a list associated with the pane (block 412). As noted above, the list may contain any of core elements 290 described above. The system determines the placement of each of the elements defined in the list within the pane. The list is then added to the panel.

If the panel is not a multi-pane panel, the system then determines if the panel is a menu form panel (block 408. If not, the panel is a list panel and the system performs blocks 412 and 414 as described above to place the list in the panel.

If the panel is a menu form panel, the system proceeds to block 420 to process the form. As discussed above, a form definition may include various types of core elements 290 as described above. The system determines the placement within the form of each of the core elements defined for the form. The completed form is then added to the panel (block 422).

FIG. 4B is an example pattern language segment illustrating an example definition 430 of a page having multiple panels 432.1-432.6, including a panel defined as having multiple panes 434.1 and 434.2.

FIG. 4C is an example screen output displayed according to the example pattern language segment 430 of FIG. 4B. Tabs 442.1-442.6 correspond to panels 432.1-432.6 respectively. Additionally, panes 444.1 and 444.2 are displays according to pane definitions 434.1 and 434.2 respectively.

FIG. 4D is a further example pattern language segment illustrating an example pattern language definition 450 of a single panel page. FIG. 4E is an example screen output displayed according to the example pattern language segment of FIG. 4D.

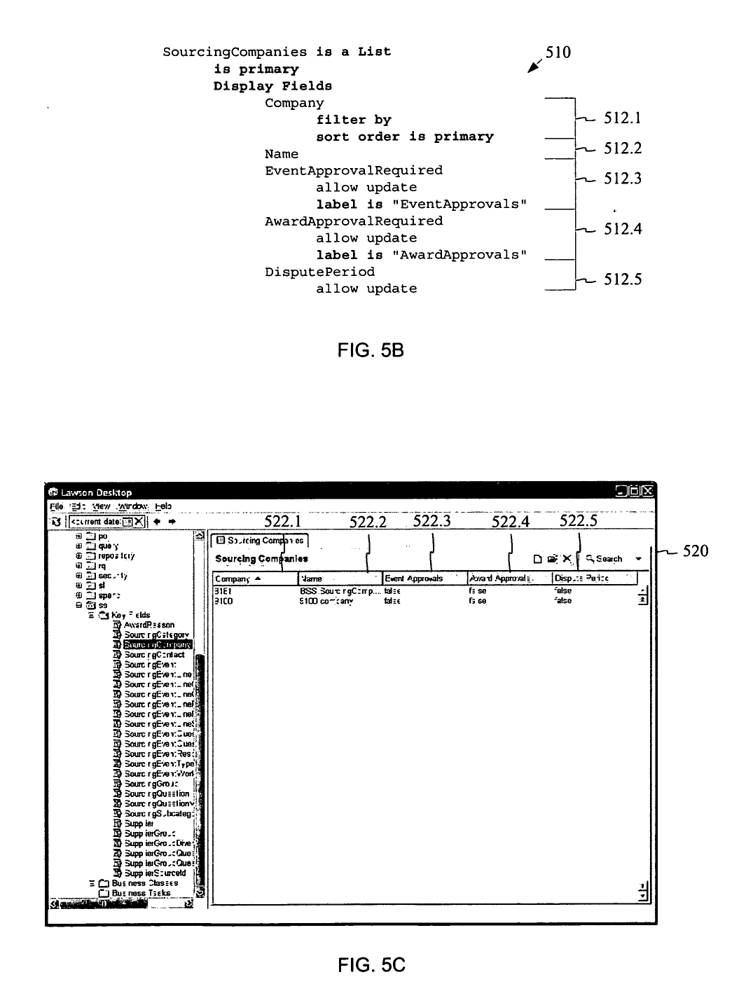

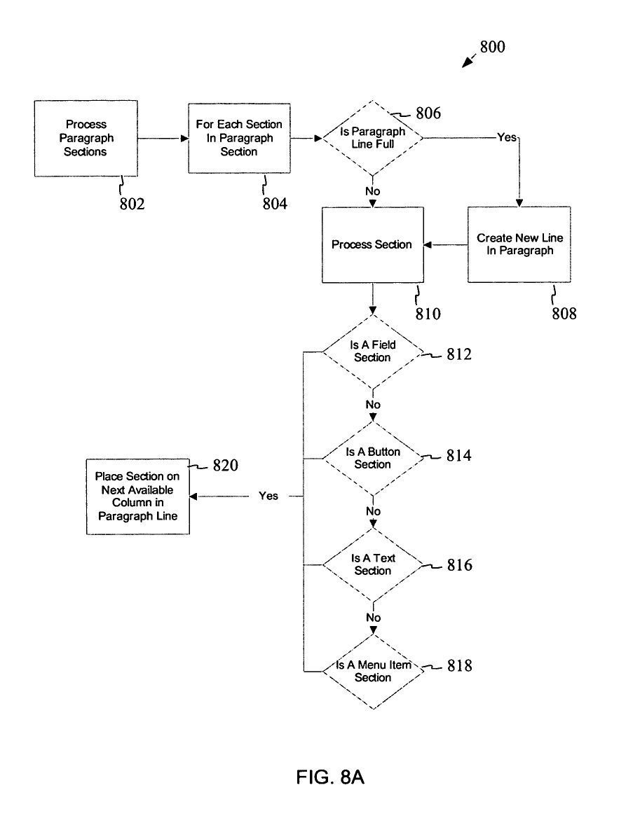

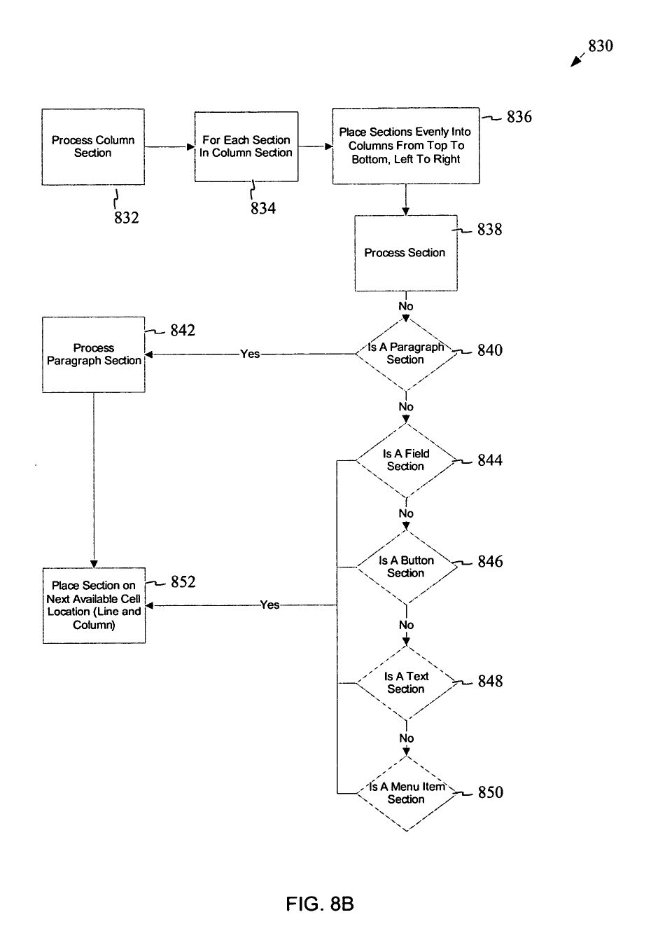

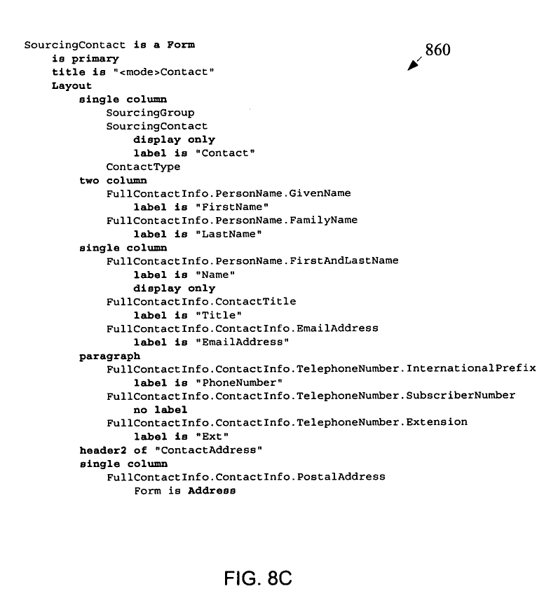

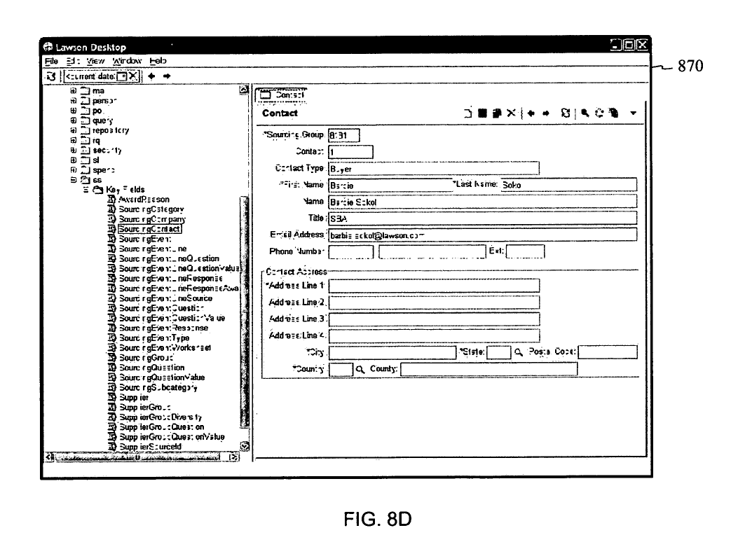

FIG. 5A is a flowchart illustrating a method 500 for processing a list of display fields according to embodiments of the invention. The method begins at block 502 by determining the display fields in a list. The system then creates a column for each display field in the list (block 504). In some embodiments, the column width is determined by giving each column the same width in the available panel width. In alternative embodiments, the column width may be a function of the field width. Additionally, the column width may be specified as a percentage of the available panel width. Further details on column processing according to embodiments of the invention are provided below with reference to FIG. 8B.

FIG. 5B is an example pattern language segment 510 illustrating a definition of a list of display fields. In the example provided, five column definitions 512.1-512.5 have been specified. FIG. 5C is an example screen output 520 displayed according to the example pattern language segment of FIG. 5B. Columns 522.1-522.5 are the resulting output according to definitions 512.1-512.5 respectively.

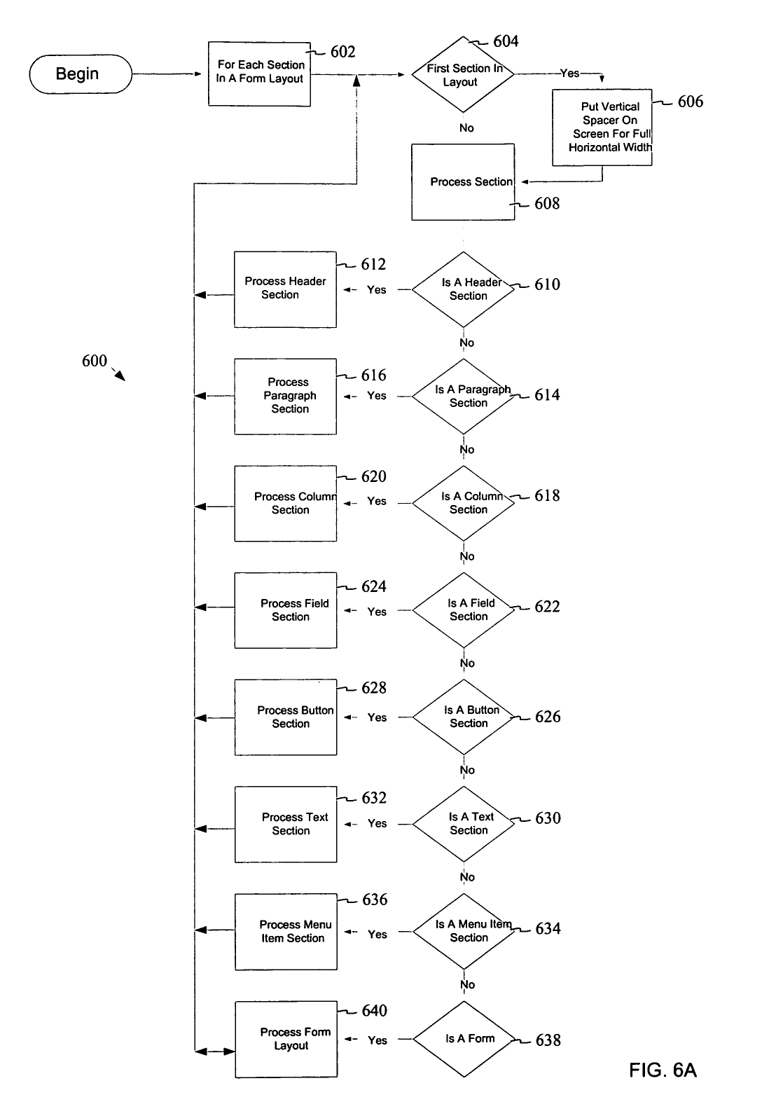

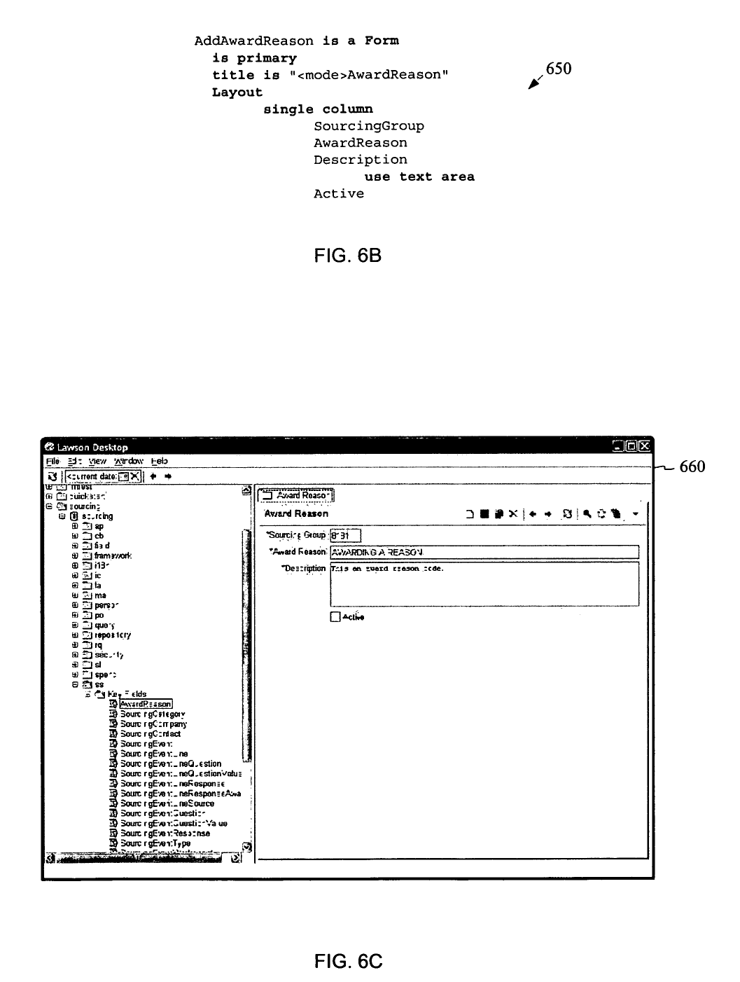

FIG. 6A is a flowchart illustrating a method 600 for processing a form according to embodiments of the invention. In some embodiments, the method begins at block 602 by processing each section defined for the form. A section may be one of the container elements 280 or a one of the core elements 290. The method starts at block 602 by determining the sections in the form. For each section, blocks 604-640 may be selectively executed. At block 604, the system checks to determine if the current section is the first section to be processed. If so, the system proceeds to block 606 to place a vertical spacer on the screen. The spacer may run the full width of the screen. The system the proceeds to block 608 to processing the section. At block 610, the system checks to determine if the section is a header section. If so, the system processes the header section at block 612 by placing the text defined for the header on the form, in the style defined for the header.

At block 614 the system checks to determine if a paragraph section is being processed. If so, the system proceeds to block 616 to process the paragraph. Further details on paragraph processing are provided below in FIGS. 8A-8C.

At block 618 the system checks to determine if the section is a column section. If so, the system proceeds to block 620 to process the column. Further details on column processing are provided below with reference to FIG. 8B.

At block 622 the system checks to determine if a field section is being processed. If so, the system proceeds to block 624 to process the field section. Processing a field section at block 624 includes placing the field data on the form according to the indentation, alignment and text styles associated with the field. In addition, if a label has been defined for the field, the label is placed on the form. Further, the field may be restricted to a specified number of lines in a text area for the field.

At block 626 the system determines if the section is a button section. If so, the system proceeds to block 628 to process the button section. Processing a button section may include placing a button image on the form and a label for the button within the button image. The label may be left, center or right justified as specified by the application designer in the pattern language section.

At block 630 the system determines if the current section is a text section. If so, the system proceeds to block 632 to process the text section. The text section may be defined as a string of text to appear on the form. The text section may have a text style indicating if the text is to be bold faced or italicized. In addition, a text section may be defined as a blank line to provide spacing on the form.

At block 634 the system determines if the section is a menu item section. If so, the system proceeds to block 636 to process the menu item section. The system places the menu labels for each menu item in the section on the form.

At block 638 the system determines if the section is a form. If so, the section is a form nested within a form. The system proceeds to block 640 and recursively processes the new form according to method 600 as described above.

In each case listed above, after processing the appropriate section the system returns to block 604 and processes the next section until all sections of the form have been processed.

FIG. 6B is an example pattern language segment 650 illustrating a definition of a form. FIG. 6C is an example screen output 660 displayed according to the example pattern language segment of FIG. 6B.

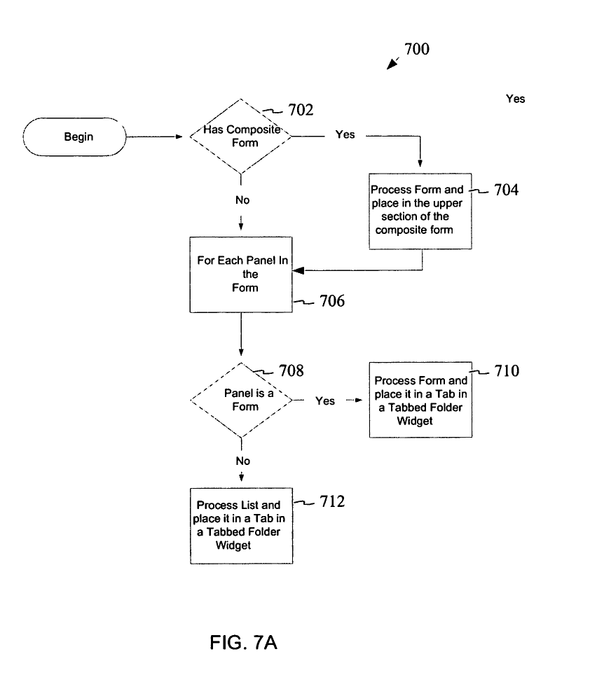

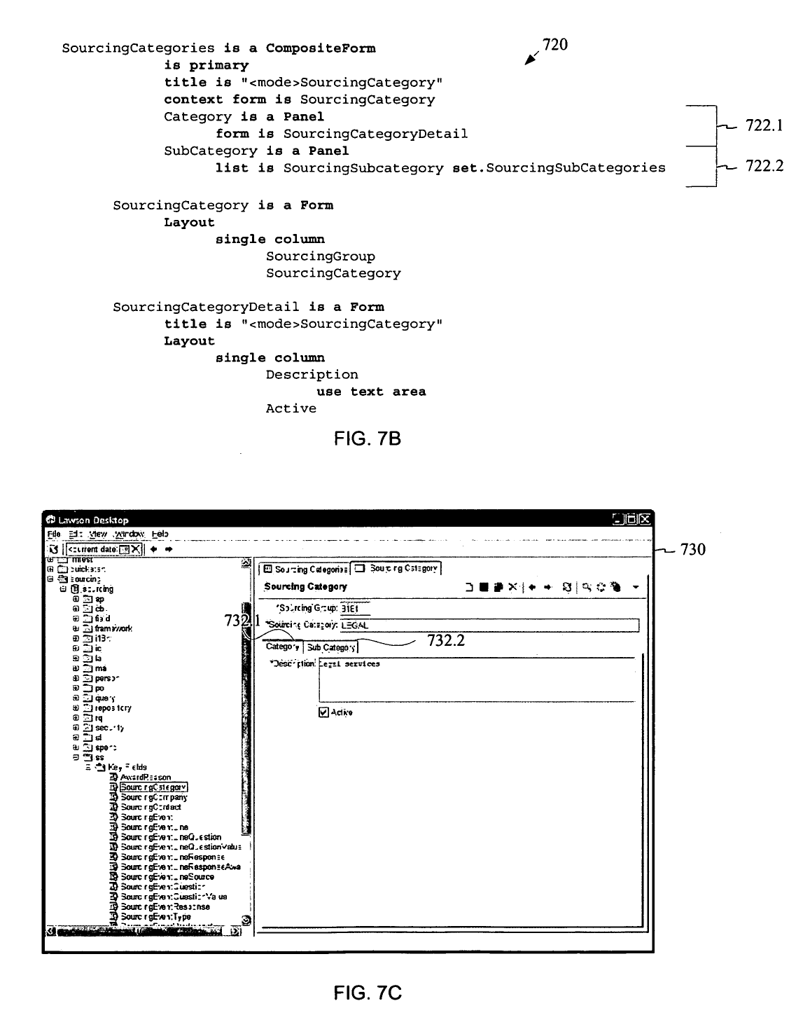

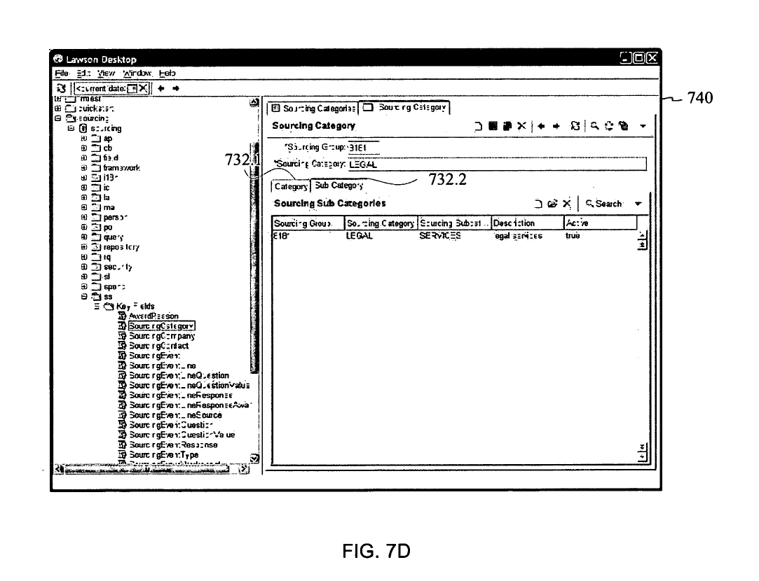

FIG. 7A is a flowchart illustrating a method 700 for processing a composite form according to embodiments of the invention. The method begins at block 702 by determining if a form has been specified as a composite form. If so, the system proceeds to block 704 to process the initial form of the composite form. Details on form processing have been provided above with reference to FIGS. 6A-6C. In some embodiments, the initial form is placed in the upper section of the composite form.

The system then proceeds to block 706 to process each panel in the composite form according to blocks 708-712. At block 708 the system determines if the current panel is a form panel. If so, the system proceeds to block 710 to process the form panel as described above in FIGS. 6A-6C. After the form has been processed, it is placed in a tab of a tabbed folder widget. If the current panel is not a form panel, the system proceeds to block 712 to process the panel as a list. The processed list is then placed in a tab of a tabbed folder widget for the composite form.

FIG. 7B is an example pattern language segment 720 illustrating a example definition of a composite form. The example definition is a composite form providing two panels 722.1 and 722.2.

FIG. 7C is an example screen output of a first page 730 of a composite form displayed according to the example pattern language segment of FIG. 7B. Tabs 732.1 and 732.2 are tabs associated with panels 722.1 and 722.2 respectively. FIG. 7C represents the display when tab 732.1 has been selected. FIG. 7D is an example screen output 740 of a second page of a composite form displayed according to the example pattern language segment of FIG. 7A. Screen output 740 is displayed when tab 732.2 has been selected.

FIG. 8A is a flowchart illustrating a method 800 for processing a paragraph section according to embodiments of the invention. A paragraph defines a group of user interface elements that are to appear together. The method begins at block 802 by determining the sections to be processed in the paragraph. Blocks 806-820 may be selectively processed for each section. At block 806 the system determines if the current paragraph line is full. If so, at block 808 the system creates a new line for further display of paragraph data. At block 610 the system processes the current section. At blocks 812-818, the system determines if the section is a field section (block 812), a button section (block 814), a text section (block 816), or a menu item section (block 818). Upon determining that the section is one of those listed above, the system proceeds to block 820 to process the section on the next available column in the current paragraph line. The system then returns to block 804 to process the next section until all sections have been processed.

FIG. 8B is a flowchart illustrating a method 830 for processing a column section according to embodiments of the invention. The method begins at block 832 by determining the sections to process in a column section. Block 836 determines the sections in the column section, and places the sections evenly into columns. In some embodiments, the sections are placed evenly into columns from top to bottom and from left to right. The columns and rows within a column define cell locations for the column section. At block 838, the system proceeds to process the current section. At block 840, the system determines if the current section is a paragraph section. If so, the system processes the paragraph section as described above with reference to FIG. 8A. At block 852, the processed paragraph section is placed in the next available cell location.

At block 844-850, the system determines if the section is a field section (block 844), a button section (block 846), a text section (block 848) or a menu section (block 850). If the section is one of the types listed, then the system proceeds to block 852 to process the section and place the section into the next available cell. Processing for the types listed has been previously described.

FIG. 8C is an example pattern language segment 860 illustrating example specifications of a paragraph section and column sections. FIG. 8D is an example screen output 870 displayed according to the example pattern language segment 860 of FIG. 8C.

The Abstract is provided to comply with 37 C.F.R. §1.72(b) to allow the reader to quickly ascertain the nature and gist of the technical disclosure. The Abstract is submitted with the understanding that it will not be used to limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus the following claims are hereby incorporated into the Detailed Description, with each claim standing on its own as a separate embodiment.

The foregoing descriptions of specific embodiments of the present invention have been presented for purposes of illustration and description. The embodiments presented are not intended to be exhaustive or to limit the invention to the particular forms disclosed. It should be understood that one of ordinary skill in the art can recognize that the teachings of the detailed description allow for a variety of modifications and variations that are not disclosed herein but are nevertheless within the scope of the present invention. Accordingly, it is intended that the scope of the present invention be defined by the appended claims and their equivalents, rather than by the description of the embodiments.

What is claimed is:

1. A method comprising:
receiving a description of a business ontology, the business ontology including business objects having fields;
receiving a pattern language segment describing a layout for one or more of the business objects;
determining an output layout for at least a subset of the fields in the one or more business objects according to the pattern language segment; and
generating code to produce the output layout.

2. The method of claim 1, wherein generating code includes generating HTML code.

3. The method of claim 1, wherein generating code includes generating Swing code.

4. The method of claim 1, wherein generating code includes generating code for a desktop application.

5. The method of claim 1, wherein the pattern language segment describes a layout in a screen size independent manner.

6. The method of claim 1, wherein determining an output layout includes determining a form layout.

7. The method of claim 6, wherein determining a form layout includes determining a composite form layout, the composite form comprising a combination of zero or more forms and zero or more lists.

8. The method of claim 1, wherein determining an output layout includes determining a list layout.

9. The method of claim 1, wherein determining an output layout includes determining a menu layout.

10. The method of claim 1, wherein determining an output layout includes determining the output layout according to a current screen size.

11. A system comprising:
a parser operable to parse a pattern language, the pattern language including definitions of one or more business objects and layout segments defining an output layout for the one or more business objects.
a repository operable to store the parsed pattern language and the parsed layout segments;
a layout analyzer operable to:
read the parsed pattern language and the parsed layout segments, and
determine an output layout; and
a code generator operable to generate code according to the output layout.

12. The system of claim 11 wherein the code generator generates HTML code.

13. The system of claim 11 wherein the code generator generates Java Swing code.

14. The system of claim 11 wherein the code generator generates Microsoft Windows display API code.

15. A computer-readable medium having disposed thereon a layout specification language for defining a user interface, the layout specification language including:
a page description element;
a menu description element;
a form description element;
a list description element;
wherein the form description element and the list description element further include core elements and wherein the form description element and the list description element are interpreted within the context of a business object of a business ontology, the business ontology defining a set of one or more attributes of the business object.

16. The computer-readable medium of claim 15, wherein the core elements include elements selected from the group consisting of field, button, text, checkbox, link, header, menu items and navigations.

17. The computer-readable medium of claim 15, wherein the form description element describes a form selected from the group consisting of basic form, composite form, matrix form, wizard form, and summary form.
